(19) United States
(12) Patent Application Publication
(10) Pub. No.: US 2025/0183761 A1
(43) Pub. Date: Jun. 5, 2025

(54) A STATOR ASSEMBLY

(71) Applicant: SAFRAN ELECTRICAL & POWER, Buckinghamshire (GB)

(72) Inventors: Paul David FLOWER, Buckinghamshire (GB); Philip INDGE, Buckinghamshire (GB); Joana CAPINHA, Buckinghamshire (GB); Jean-Michel Bernard Paul CHASTAGNIER, Buckinghamshire (GB); Anthony KELLY, Buckinghamshire (GB)

(21) Appl. No.: 18/836,673

(22) PCT Filed: Feb. 7, 2023
(86) PCT No.: PCT/GB2023/050266

§ 371 Date: Aug. 7, 2024

(30) Foreign Application Priority Data
Feb. 8, 2022 (GB) 2201622.4

(51) Int. Cl. H02K 9/197; B64D 33/08; H02K 3/24; H02K 7/18

(52) U.S. Cl. CPC H02K 9/197; H02K 3/24; B64D 33/08; H02K 7/1823

(57) ABSTRACT

A stator assembly includes a stator core including a plurality of teeth and at least one axially extending slot for receiving an electrical conductor disposed between adjacent teeth; and a sealing element extending around at least a part of the circumference of the stator to form at least one bridge portion extending over a radially oriented opening of the at least one slot, to form a fluidic seal over the radially oriented opening. The sealing element includes at least one tooth tip portion extending across at least a part of a substantially radially facing tip of at least one tooth of the stator; at least one bridge section extending circumferentially across the radially oriented opening of the at least one slot and extending radially into the at least one slot. A supplementary sealing element forms a second layer extending around at least part of the circumference of the stator.

### TECHNICAL FIELD

The present invention relates to a stator assembly for an electrical machine for use in an aircraft.

### BACKGROUND

An electrical machine, either a motor or a generator, generally comprises a rotor assembly configured to rotate on a shaft within a bore of a stationary stator assembly. The rotor assembly and the stator assembly also comprise an air gap therebetween. The interaction of the magnetic fields of the respective assemblies converts electrical energy to mechanical energy in a motor, or mechanical energy to electrical energy in a generator. During operation, the losses of the electrical machine can generate large amounts of heat energy in the stator.

In high-power machines in particular, oil cooling may be preferable to air cooling. Oil possesses a higher specific heat capacity than air and thus draws heat energy away from the stator assembly more effectively. Additionally, and advantageously, the oil may be used for both cooling and lubrication while being circulated by a single pump, which may contribute to weight-saving in the aircraft.

In certain cases, electric machines may be provided with cooling channels formed in the slots of the stator assembly, through which oil may pass to remove heat from the stator. Solutions are needed for managing the oil pressure and flow generated in such cooling channels.

The present invention seeks to provide an improved stator assembly which overcomes or mitigates one or more problems associated with the prior art.

### SUMMARY OF THE INVENTION

According to a first aspect of the invention, there is provided a stator assembly for an electrical machine, the stator assembly comprising:
a stator core comprising a plurality of stator teeth and at least one axially extending slot for receiving an electrical conductor disposed between adjacent stator teeth; and
a sealing element forming a first layer extending around at least a part of the circumference of the stator to provide at least one bridge portion extending over a radially oriented opening of the at least one slot, to form a fluidic seal over the radially oriented opening;
wherein the sealing element comprises:
at least one tooth tip portion extending across at least a part of a substantially radially facing tip of at least one stator tooth;
at least one bridge section extending circumferentially across the radially oriented opening of the at least one slot and extending radially into the at least one slot; and
a supplementary sealing element forming a second layer extending around at least part of the circumference of the stator and co-operating with the sealing element to create at least one cavity between the bridge portion and the supplementary sealing element.

This configuration provides the sealing element with a profile that allows maintenance of a minimal magnetic air gap between the stator and the rotor, while providing increased strength. The adhesive connection between the bridge section and the slot wall against which it is abutted is loaded in a condition of shear to a greater degree as compared to the condition of peel which is predominant in the adhesive connection between the sealing element and the stator tooth tip portions when a cylindrical sealing element is used. As shear stresses are less concentrated than peel stresses, the service life of the sealing element may be increased.

The bridge section may comprise at least one radial extension extending radially into the at least one slot of the stator; and/or at least one circumferentially extending bridge section extending circumferentially across the at least one slot.

The at least one radial extension of the bridge section may extend against a radially extending wall of the at least one slot.

Advantageously, this configuration provides more simple manufacturability. The at least one radial extension may be abutted by an inner wall of the axially extending slot, for example, which can enable in situ manufacture of the sealing element, and can further improve the integrity of the connection between the bridge section and the stator teeth, since shear stresses are applied to the adhesive connection between the sealing element and the slot wall against which it is abutted, in addition to any peel stresses which may be present in the adhesive connection between the sealing element and the tooth tip or tips, which provides improved stress distribution and reduced stress concentrations.

At least two bridge sections of the sealing element may be formed continuously with the tooth tip portion of the sealing element therebetween.

Each bridge section of the sealing element may be formed continuously with each adjacent bridge section and the tooth tip portion of the sealing element therebetween.

The sealing element may comprise or may be formed of a single layer of material.

Forming the sealing element to comprise or to be formed of a single layer of material contributes to providing a minimised magnetic air gap between the stator and rotor, and thus improved electromagnetic performance. Additionally, this confers the advantages of quicker manufacture and weight savings for the final assembly.

The sealing element may comprise a composite material. The sealing element may comprise a fibre-reinforced polymer composite.

The sealing element may comprise glass fibre.

At least one support member may be disposed within and may extend across at least one slot of the stator core to support the bridge portion.

The stator assembly may further comprise a filler material disposed within at least one cavity formed by an inward extension of the bridge portion into the slot.

The filler material reinforces the structure of the sealing element and, by being disposed within the cavity, does not require the air gap to be larger in order to do this. By reinforcing the sealing element, oil is more effectively retained within the cooling channels and conductors are more effectively retained in place.

The filler material may comprise an expandable material. Advantageously, this does not require the filler material to be precisely dimensioned by a machining process. Instead, the filler material may be arranged within the at least one cavity and expand to the appropriate dimensions itself.

The filler material may comprise a syntactic foam.

The stator assembly may further comprise magnetically permeable material disposed within at least one cavity formed by the inward extension of the bridge portion into the slot.

The supplementary sealing element may be formed of a single layer of material.

The supplementary sealing element may comprise a composite material.

The supplementary sealing element may comprise a fibre-reinforced polymer composite.

The supplementary sealing element may comprise glass fibre.

According to a second aspect of the invention, there is provided a method of forming a stator assembly for an electrical machine, comprising the steps of:
providing a stator core comprising a plurality of teeth and at least one axially extending slot for receiving an electrical conductor disposed between adjacent teeth; and
providing a sealing element extending around at least a part of the circumference of the stator to form at least one bridge portion extending over a radially oriented opening of the at least one slot, to form a fluidic seal over the radially oriented opening;
   wherein the sealing element comprises:
at least one tooth tip portion extending across at least a part of a substantially radially facing tip of at least one tooth of the stator;
   at least one bridge section extending circumferentially across the radially oriented opening of the at least one slot and extending radially into the at least one slot; and
providing a supplementary sealing element forming a second layer extending around at least part of the circumference of the stator and co-operating with the sealing element to create at least one cavity between the bridge portion and the supplementary sealing element.

The method of the invention may further comprise providing any of the features of the product as described above, or in the following description.

### BRIEF DESCRIPTION OF THE DRAWINGS

Further features and advantages of the present invention will be further described below, by way of example only, with reference to the accompanying drawings in which:

FIG. 1 is a perspective view of part of a stator assembly for the illustration of the present invention;

FIG. 2 shows a cross-section view through a part of a stator assembly according to embodiments of the invention; and

FIG. 3 shows a schematic diagram illustrating an aircraft and an electric machine according to embodiments of the invention.

### DETAILED DESCRIPTION

Electric machines may be provided with cooling channels formed in the slots of the stator assembly through which oil may pass to remove heat from the stator. One solution may be to provide a sleeve disposed in the bore of the stator such that the slots are closed and the oil is retained within the sleeves in the cooling channels. However, where the oil pressure is high pressure or high flow rates are required, such as in high power electric machines, for example in high power propulsion motors or generators, the pressure of the cooling oil can cause the sleeve to fail by rupture or by peeling off ends of the stator teeth.

One way to address this problem is to provide a sleeve with an increased thickness. This solution increases the strength of the sleeve and reduces the likelihood of failure; however, this also increases the size of the magnetic air gap between the stator and the rotor and worsens the electromagnetic performance of the generator. In this context, a magnetic air gap is a gap between magnetically active materials and may not necessarily be filed with air. Therefore, even if filled with a reinforcing non-magnetically-active component, this region may still be considered to be the magnetic air gap, or the magnetic gap.

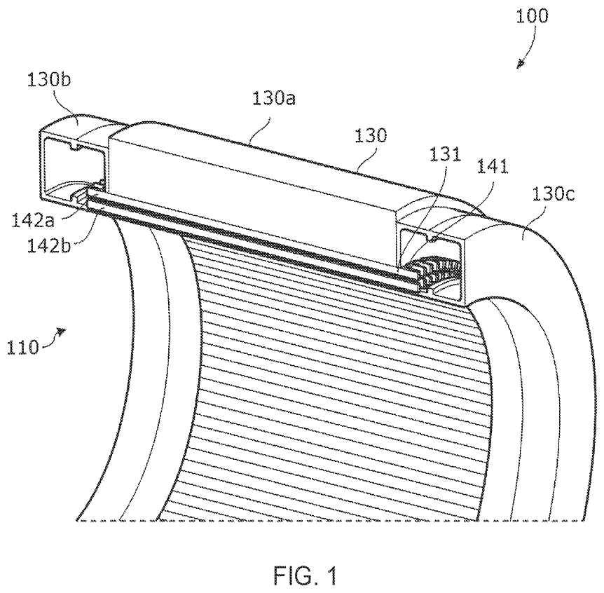

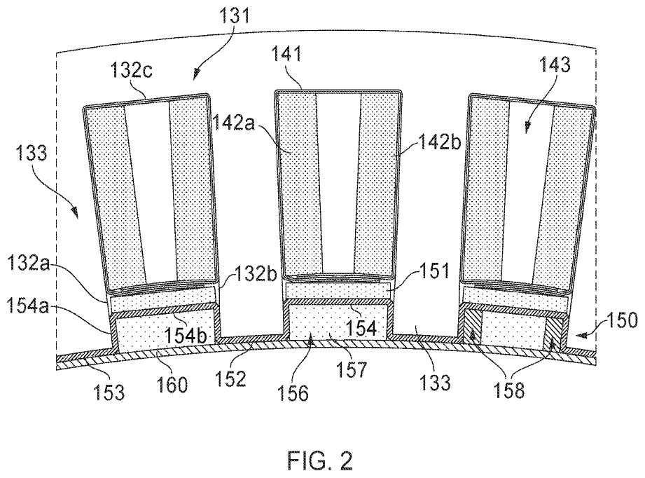

As shown in FIG. 1, there is provided a stator assembly 100. The stator assembly 100 comprises a stator core 130, electrical conductors 142a and 142b, a slot liner 141 may be provided in a slot 131 in which the conductor is provided, and a cooling channel 143, as denoted in FIG. 2, may be provided for guiding a cooling fluid, which may comprise a liquid cooling fluid, which may comprise oil.

The stator core 130 comprises at least one slot 131 for receiving one or more electrical conductors 130. As a person skilled in the art will appreciate, the stator core 130 is typically configured to at least partially surround a rotor (not shown) of a generator, and typically carries a plurality of slots extending substantially longitudinally with respect to a rotational axis of the rotor within the stator. The conductors in such an electric machine are configured to interact with a rotating magnetic field generated by the rotor, either by permanent magnets or electromagnetic windings. The stator core 130 comprises a core body 130a and in the illustrated arrangement may be provided with first and second manifolds 130b, 130c which can be configured to provide a flow of coolant to and from respective ends of the core body 130a.

The core body 130a is configured to at least partially receive a rotor which is generally rotationally mounted within a bore 110 of the stator assembly 100. Thus, the core body 130a may have a hollow cylindrical shape, wherein the hollow part of the cylindrical shape is configured to receive the rotor. Specifically, the core body 130a may define an open-ended tube shape. The core body 130a may be substantially symmetrical about a central axis. The two manifolds 130b, 130c, may have substantially the same shape and/or size as each other, but may be formed differently. Their function is to act as a manifold to distribute the flow, which may arrive from a coolant circuit (not shown) to ends of the multiple slot liners 110, to allow coolant fluid to flow along the slot liners. One of the manifolds 130b, 130c may therefore act as an inlet manifold, configured to guide coolant to an inlet end of the slot liners 110, while the other may act as an outlet manifold, configured to collect coolant flow from outlet ends of the slot liners and return it to the coolant circuit. The two manifolds 130b, 130c may each be arcuate, and may each define a circle. The two manifolds 130b, 130c, may be configured to contact, and may be fixedly attached to, the core body 130a. Each manifold 130b, 130c may be hollow. Each manifold 130b, 130c may be configured to receive an end of the at least one electrical conductor 130. Each manifold 130b, 130c may be configured to receive an end of a slot liner 110, if provided, or a plurality of slot liners 110, if provided.

The stator core 130, specifically the core body 130a, may comprise a magnetisable material. The stator core 130, specifically the core body 130a, may comprise iron or other soft magnetic alloy. The stator core 130, specifically the core body 130a, may comprise a laminated material.

The stator core 130 comprises a plurality of slots 131, each being configured to receive one or more electrical conductors 130. The or each slot 131 can be configured to receive at least one electrical conductor 130, and may be configured to accommodate two or more conductors arranged in parallel.

FIG. 2 illustrates a cross-section through a number of slots 131 of the stator core 130. The or each slot 131 may comprise a first side wall 132a, a second side wall 132b, and an end wall 132c. The first and second side walls 132a, 132b may be opposing walls, substantially facing one another. Viewed in cross-section as in FIG. 2, the first and second side walls 132a, 132b may each have a radial depth dimension, specifically a depth running in a direction from an opening of the slot 131 to the end wall 132c substantially opposite the opening. The depth of the first side wall 132a may be substantially the same as the depth of the second side wall 132b. The first side wall 132a may be substantially parallel to the second side wall 132b, but may be at a slight angle to the second side wall 132b due to the circumferential angular spacing of the walls, which may extend in a radial direction of the stator. The end wall 132c may have a circumferential dimension, specifically a width in a tangential or circumferential direction. The width of the end wall 132c may be substantially perpendicular to the depth of the first and/or second side wall 132a, 132b. The width of the end wall 132c may be less than the depth of the first and/or second wall 132a, 132b. The side walls 132a, 132b and the end wall 132c may define two corners in a region where the walls meet. The two corners may be arcuate.

The electrical conductor 142 is at least partially disposed in the at least one slot 131. In the arrangement illustrated in FIG. 2, each slot 131 optionally receives both a first electrical conductor 142a and a second electrical conductor 142b. The first electrical conductor 142a and the second electrical conductor 142b may have substantially the same shape and size of cross-section as each other, as also shown in FIG. 2, but may also be differently sized or shaped. The first and/or second electrical conductors 142a, 142b may each have at least one substantially straight edge. The first and/or second electrical conductors 142a, 142b may each have two substantially straight edges when viewed in cross-section as shown in FIG. 2. The two substantially straight edges of each electrical conductor 142a, 142b may be on opposite sides of the electrical conductor 142a, 142b to each other. Each electrical conductor 142a, 142b may have a width and a depth, the depth being larger than the width, and the substantially straight edge being arranged such that it extends in the direction of the depth. The electrical conductors 142a, 142b may each have a symmetrical cross-section. The first and second electrical conductors 142a, 142b may each be elongate, as shown in FIG. 1. The or each slot 131 can be configured to extend from an axial end opening at a first end of the core body 130a to a second axial end opening at a second end of the core body 130a, such that the conductor and its coolant can pass axially from one end of the core body to the other end of the core body. The slot 131 and the first and/or second electrical conductors 142a, 142b may each be configured such that they can extend from one of the two manifolds 130b, 130c of the stator core 130 to the other of the two manifolds 130b, 130c. The first and second electrical conductors 142a, 142b may each be a single unitary piece of material. The first and second electrical conductors 142a, 142b may comprise an electrically conductive material, such as copper. For example, the first and second electrical conductors 142a, 142b may comprise insulated copper members or bars.

The stator 100 may comprise part of a multi-phase machine. Therefore, the conductors 142 of the stator may comprise more than one phase. For example, the conductors 142 may comprise two or more phases. In the arrangement illustrated in FIG. 2, the conductors 142 comprise three phases. Each slot 131 may therefore comprise conductors from two or three phases in a single slot.

As will be appreciated from the Figures, the cooling channel along which coolant can flow is disposed within the slot liner 141, between electrical conductors 142a, 142b. The cooling channel 143 may be configured such that fluid can flow from one end of the stator core 130 to another end of the stator core 130. Specifically, the cooling channel 143 may be configured such that fluid can flow from one of the two manifolds 123 of the stator core 130 to the other 124 of the two manifolds of the stator core 130. As will be appreciated from the Figures, the cooling channel 143 may be configured such that fluid can flow from one end of the electrical conductor 142 to another end of the electrical conductor 142. As a skilled person will appreciate, the cooling channel 143 may be configured such that fluid can flow from a centre point of the electrical conductor 142 to one or more ends of the electrical conductor 142. The cooling channel 143 can thus be configured so as to allow for heat conduction away from the electrical conductor 142, by means of a cooling fluid flowing through the cooling channel 143. The flow being adjacent the wall of the conductor allows for better heat transfer from the conductor to the cooling fluid.

The slot liner 141 is at least partially disposed in the at least one slot 131, between the stator core 130 and the electrical conductor 142. The slot liner 141 can be configured to be received in the stator core 130, specifically in a slot 131 of the stator core 130. The slot liner 141 is configured to receive an electrical conductor 142 and to form a cooling channel between the slot liner and the wall of the conductor. The slot liner 141 may comprise an electrically insulating material. The slot liner 141 may comprise a polymer, which may be one or more of: polyether ether ketone; polyphenylene sulphide; polyamide-imide; polytetrafluoroethylene.

In cross-section, the slot liner 141 may surround the conductors 142a, 142b so as to retain any fluid flowing around the conductors 142a, 142b within the slot liner 141. Whether completely surrounding the slot liner 141 or not, the slot liner 141 is arranged to retain fluid within a cooling channel 143 formed between the slot liner 141 and the conductors 142a, 142b. The cooling channel 143 may be formed between an inner wall of the slot liner and an outer wall of the conductor. The channel 143 can be formed by a recess created in the inner wall of the slot liner, or in a recess formed in an outer wall of the conductor, or both.

The stator assembly 100 further comprises a sealing element 150, which extends around at least a part of the circumference of the stator. The sealing element 150 may extend around substantially the whole circumference of the stator. The provision of the sealing element 150 is to prevent the leakage of coolant into the air gap defined between the stator assembly 100 and the rotor (not shown) in the event that the slot liner 141 leaks.

The sealing element 150 comprises a primary sealing element 152. The primary sealing element 152 extends across at least one of the plurality of slots 131. In the illustrated embodiment, the primary sealing element 152 comprises tooth-tip portions 153 which extend circumferentially across tooth tips of the teeth of the stator assembly 100. The primary sealing element 152 further comprises bridge sections 154 which extend across the openings of the slots 131 of the stator assembly 100. Each bridge section 154 extends circumferentially across the opening of the slot 131 and also extends radially into the at least one slot 131.

The bridge section 154 of the primary sealing element 152 may further comprise at least one radial extension 154a, as shown in FIG. 2. The radial extension 154a connects the tooth-tip portion 153 to the circumferentially extending part of the bridge section 154 and extends radially into the at least one slot 131 of the stator assembly. Thus, the radial extensions 154a and the bridge sections 154 of the primary sealing element 152 may define castellated profiles. It will be understood that the bridge section 154 therefore defines a cavity 156 in the slot 131. The cavity is within the slot, and is also on an opposite side of the bridge section to the conductor(s) 142a and 142b. In other arrangements, a radial extension of the bridge section 154 may be achieved by curvature of the bridge section 154 into the slot between the tooth tips, with or without the radially extending portion 154a extending along the wall 132a, for example.

Optionally, the radial extensions 154a extend against the inner walls 132a, 132b of the slots 131. The inner walls 132a, 132b may comprise an incline relative to the direction in which they extend from the tooth tips 133, as shown in the illustrated arrangement. In cases where the opposing inner walls 132a, 132b are non-parallel such that the distance between them increases away from the central axis of the stator, a ‘keystone’ effect can be created, since in such an arrangement the distance from wall 132a to 132b is greater at the position of the bridges 154b than at the radial opening of the slot, and the bridges 154b would have to be compressed circumferentially if they were to advance towards the radially-inward facing opening of the slot or slots.

Optionally, the radial extensions 154a are bonded by adhesion to the inner walls 132a, 132b of the slots 131. Thus, if the inner walls 132a, 132b are non-parallel relative to one another, the radial extensions 154a also incline by the same angle relative to the direction normal to the tooth tips 133. With this arrangement, the bridge sections 154 are configured to mechanically behave similarly to ‘keystones’ in arched structures. The bridges 154b of the bridge sections 154 therefore help to bear the load of any oil pressure within the cooling channels 143.

Advantageously, with this configuration, the sealing element 150 is adhesively bonded to the stator assembly 100 in a shear condition as the radial extensions 154a are bonded to the inner walls 132a, 132b of the slots 131. This can provide better strength of the bonding as compared to the peel strength provided between the tooth-tip portions 153 and the tips of the teeth 133 alone. Greater resistance to oil pressures within the slots can therefore be achieved. Over the service life of the sealing element 150 and the stator, the combination of shear loading applied to the adhesive connection between the radial extensions 154a of the sealing element 150 and the inner walls 132a, 132b against which they are abutted is preferable to a condition of peel. This is because peel stress is exerted on adhesive over thin sections in high concentrations and therefore the peeling condition of adhesion can be more susceptible to fatigue. Conversely, shear stress is a more favourable loading condition, since in the disclosed arrangements it is distributed more evenly than peel stress. Adhesive in the condition of shear may be therefore more resistant to creep (the tendency of a solid to deform over time at increased stress and/or temperature), and shear can generally be more resistant to forces in either direction parallel to the adhesion.

It will be understood that the radial extension 154a of the bridge section 154 is optional. Without radial extensions 154a, the bridge sections 154 of the primary sealing element 152 may instead define arched profiles, for example.

The sealing element 150 may further comprise a filler material 157 disposed within the cavity 156 defined in the slot 131 by the bridge section 154. The filler material 157 may be a material comprising a high specific strength and a low density. As the bridge section 154 extends radially into the slot 131 and the cavity 156 is defined therein, the filler material 157 may provide increased strength to the structure of the sealing element 150 without the need to increase the thickness of the sealing element 150 and therefore increase the distance of the gap between the stator assembly 100 and the rotor (not shown).

For example, the filler material 157 may comprise a syntactic foam. Advantageously, syntactic foams comprise a high porosity, low density and high compressive strength; providing increased strength to the structure of the sealing element 150 without a significant increase in weight. The filler material 157 may comprise magnetically permeable material. This can enhance the electromagnetic performance of the generator. The filler material 157 may partially comprise magnetically permeable material. Where the filler material 157 comprises syntactic foam or any suitable porous material, the magnetically permeable material may be disposed within pores of the porous material. The magnetically permeable material may only be provided in certain zones or sub-regions of the filler material or of the cavity provided between the bridge portion of the sealing element and the supplementary sealing element.

For example, the filler material 157 may at least partially comprise magnetically permeable material disposed in zones 158 which are proximal to the tooth tips, which may be adjacent the radial extensions 154a of the bridge section 154. In effect, the magnetically permeable material may comprise a circumferential extension of the magnetically active material of the adjacent tooth tip, which in turn can increase the magnetically active area of the stator assembly. Advantageously, with this configuration, the sealing element may perform the function of a lightweight and thin fluidic seal, while also enhancing the electromagnetic performance of the generator.

In the embodiment of FIG. 2, the stator assembly 100 further comprises a supplementary sealing element 160. The supplementary sealing element 160 comprises a layer of material which is arranged to extend around the inner circumference of the first sealing layer 152. In embodiments in which the supplementary sealing element 160 extends around substantially the whole inner circumference of the first sealing layer 152, the supplementary sealing element 160 is substantially annular.

The supplementary sealing element 160 reinforces the structure of the sealing element 150 and provides an additional layer through which stress within the cooling channels 143 may be distributed. The provision of this additional layer thus increases the maximum allowable load within the cooling channels 143 and reduces the likelihood of failure of the sealing element 150.

The method of forming the sealing element 150 may first comprise the step of providing an optional support member 151 disposed within the slots 131. The support member 151 comprises a member which extends transverse to the opening of the slot 131 and may be arranged to be abutted by the slot liner 141.

The method may subsequently comprise the step of providing the first sealing layer 152. The first sealing layer 152 may comprise a composite material. It will be understood that this term can refer to any multi-phase material. The continuous phase in a composite is referred to as the matrix whilst other phases provide reinforcement. The term includes fibre, whisker and platelet reinforced materials, particulate composites such as dispersion strengthened alloys and cermets, laminates and sandwich materials. The first sealing layer 152 may comprise a fibre-reinforced composite material. The first sealing layer 152 may comprise a pre-impregnated fibre-reinforced composite material.

To provide the first sealing layer 152, composite material is laid up within the bore of the stator 100. The composite material is laid up such that it extends across a tip of at least one tooth 133 of the stator 100, extends circumferentially across the radially oriented opening of at least one slot 131 and extends radially into the at least one slot 131. In the embodiment of FIG. 2, the composite material is laid up such that it extends across the tip of each tooth 133 of the stator 100, providing a continuous, optionally castellated, structure which extends circumferentially across the opening of each slot 131 and extends radially into each slot 131. The composite material is abutted within each slot 131 by the support members 151 and cured in situ thereafter. During the curing process, the support members 151 act as a clamp to ensure that even pressure is exerted on the composite material within the slot and can help to provide more uniform mechanical properties.

The first sealing layer 152 may otherwise be pre-formed. For example, the primary sealing element 152 may be provided by forming the first sealing layer 152 on an optionally castellated mould, instead of on the stator assembly. With this arrangement, the primary sealing element 152 is installed to the stator assembly 100 after being cured. The sealing layer 152 may be formed by laying up a composite material on the mould as described.

In known methods, a wedge may be forced into each slot of the stator to provide a sealing element. For example, the wedge may be hammered in or inserted under force such that the wedge is retained in the slot in an “interference”, or “press”, fit. The forces involved in these methods of manufacture may distort the stator assembly.

Following the provision of the primary sealing element 152, a filler material 157 may be provided in the cavities 156 in the bridge sections 154 of the primary sealing element 152. In some embodiments, the filler material 157 is an expandable material. The person skilled in the art will understand that an expandable material is configured to increase in length, area or volume. The material may be configured to expand as a result of thermal changes. For example, the filler material 157 may comprise a foam. Foams generally comprise sandwich materials containing cores of foamed polymers, may be considered as composites. In addition, foams may be reinforced with fibres. The filler material 157 may comprise a syntactic foam. Syntactic foams consist of polymers filled with hollow microspheres of glass or expanded polymers. The presence of the hollow microspheres reduces the density of the overall foam, resulting in a higher specific strength. With this configuration, the weight of the stator assembly 100 is advantageously not significantly increased by the filler material 157 despite the filler material 157 providing additional strength to the sealing element 150.

Optionally, magnetically permeable material may be arranged within the cavities 156 of the primary sealing element 152. This increases the effective area of the magnetic circuit and in turn enhances the electromagnetic performance. As air gaps are non-magnetic, they comprise increased reluctance when compared with the windings of the stator and the permanent magnets of the rotor. Therefore, to improve electromagnetic performance, the air gap between the stator assembly 100 and the rotor (not shown) is preferably as small as is practicable.

The method may also optionally comprise the provision of the supplementary sealing element 160. The supplementary sealing element 160 can be laid up within the inner circumference of the primary sealing element 152. It may be laid up such that it extends across at least a part of the circumference of the primary sealing element 152. Optionally, the supplementary sealing element 160 extends continuously around the circumference of the primary sealing element 152 such that it provides an annular second layer. Similarly to the primary sealing element 152 of the sealing element 150, the supplementary sealing element 160 may comprise a fibre-reinforced composite material. The supplementary sealing element 160 may comprise a pre-impregnated fibre-reinforced composite material. After being laid up, the supplementary sealing element 160 may be cured in situ. As with the primary sealing element 152 of the sealing element 150, the supplementary sealing element 160 may otherwise be pre-formed.

Embodiments comprising all of the first sealing layer 152, the filler material 157 and the supplementary sealing element 160 therefore define a “sandwich” construction. Sandwich materials are generally comprised of two skin materials bonded to a lightweight core material, though may otherwise comprise several layer combinations. In the embodiment of FIG. 2, the skin materials comprise the primary sealing element 152 and the supplementary sealing element 160 while the lightweight core comprises the filler material 157. A sandwich construction provides a low-density structure with a high specific stiffness. In such a construction, the maximum tensile and compressive stresses are generally carried by the skin layers.

It will be appreciated that the provision of the filler material 157 and the supplementary sealing element 160 confers further advantages, but neither are essential. In some embodiments, the stator assembly 100 may comprise either, both or neither of the filler material 157 and the supplementary sealing element 160.

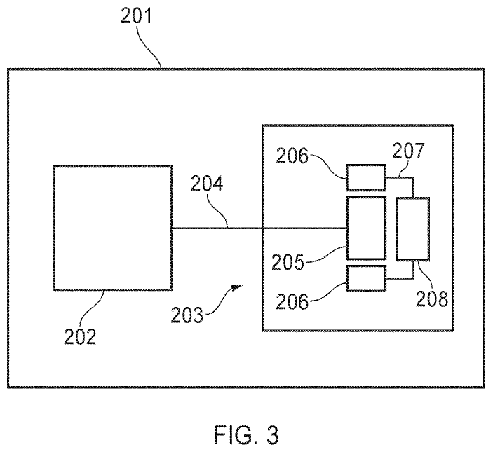

FIG. 3 schematically illustrates an aircraft 201 comprising an aircraft engine 202 and an electric machine, such as a generator 203, which may in some instances be a motor or a starter-generator. The aircraft engine 202 is able to transfer drive to the generator 203 via a generator input shaft assembly 204. The generator input shaft assembly 204 is operable to transfer drive to a rotor 205 of the generator 203.

The rotor 205 may comprise permanent magnets seated in slots. The rotor 205 may be rotatably mounted within a bore of the stator 206. Generally, the stator 206 may comprise conductors, the conductors comprising electrically conductive material, within slots. Each slot may comprise conductors from two or three phases in a single slot. The rotation of the rotor 205 within the stator 206 and the electromagnetic interaction between the magnetic field of the permanent magnets of the rotor and the conductors of the stator 206 generates electrical power which may be used to power one or more components of the aircraft 201.

For example, the generator 203 may provide electrical power to a fluid pump 208. The fluid pump 208 may circulate fluid to one or more coolant channels (not shown) within the stator 206. The structures described in relation to FIGS. 1 and 2 can advantageously be incorporated into the electric machine 203. The fluid pump 208 may circulate fluid to the input shaft assembly 204 for lubrication. It will be understood that the fluid pump 208 may advantageously be configured to perform the two described functions, reducing the number of parts required in the aircraft 201 to cool and lubricate the components therein.

Various modifications, whether by way of addition, deletion and/or substitution, may be made to all of the above described embodiments to provide further embodiments, any and/or all of which are intended to be encompassed by the appended claims.

1. A stator assembly for an electrical machine, the stator assembly comprising:
a stator core comprising a plurality of stator teeth and at least one axially extending slot for receiving an electrical conductor disposed between adjacent stator teeth; and
a sealing element forming a first layer extending around at least a part of the circumference of the stator to provide at least one bridge portion extending over a radially oriented opening of the at least one slot, to form a fluidic seal over the radially oriented opening; wherein the sealing element comprises:
at least one tooth tip portion extending across at least a part of a substantially radially facing tip of at least one of the stator teeth;
at least one bridge section extending circumferentially across the radially oriented opening of the at least one slot and extending radially into the at least one slot;
a supplementary sealing element forming a second layer extending around at least part of the circumference of the stator and co-operating with the sealing element to create at least one cavity between the bridge portion and the supplementary sealing element; and
a filler material disposed within the at least one cavity formed by an inward extension of the bridge portion into the slot.

2. The stator assembly of claim 1, wherein the bridge section comprises at least one radial extension extending radially into the at least one slot of the stator; and/or at least one circumferentially extending bridge section extending circumferentially across the at least one slot.

3. The stator assembly of claim 1, wherein the at least one radial extension of the bridge section extends against a radially extending wall of the at least one slot.

4. The stator assembly of claim 1, wherein at least two bridge sections of the sealing element are formed continuously with the tooth tip portion of the sealing element therebetween.

5. The stator assembly of claim 4, wherein each bridge section of the sealing element is formed continuously with each adjacent bridge section and the tooth tip portion of the sealing element therebetween.

6. The stator assembly of claim 1, wherein the sealing element is formed of a single layer of material.

7. The stator assembly of any claim 1, wherein the sealing element comprises a composite material.

8. The stator assembly of claim 7, wherein the sealing element comprises a fibre-reinforced polymer composite.

9. The stator assembly of claim 8, wherein the sealing element comprises glass fibre.

10. The stator assembly of claim 1, wherein at least one support member is disposed within and extends across at least one slot of the stator core to support the bridge portion.

11. (canceled)

12. The stator assembly of claim 1, wherein the filler material comprises an expandable material.

13. The stator assembly of claim 12, wherein the filler material comprises a syntactic foam.

14. The stator assembly of claim 1, further comprising a magnetically permeable material disposed within at least one cavity formed by the inward extension of the bridge portion into the slot.

15. The stator assembly of claim 1, wherein the supplementary sealing element is formed of a single layer of material.

16. The stator assembly of claim 1, wherein the supplementary sealing element comprises a composite material.

17. The stator assembly of claim 16, wherein the supplementary sealing element comprises a fibre-reinforced polymer composite.

18. The stator assembly of claim 17, wherein the supplementary sealing element comprises glass fibre.

19. An electric machine comprising a stator assembly according to claim 1.

20. An aircraft comprising the electric machine of claim 19.

21. A method of forming a stator assembly for an electrical machine, comprising the steps of:
providing a stator core comprising a plurality of teeth and at least one axially extending slot for receiving an electrical conductor disposed between adjacent teeth; and
providing a sealing element extending around at least a part of the circumference of the stator to form at least one bridge portion extending over a radially oriented opening of the at least one slot, to form a fluidic seal over the radially oriented opening, wherein the sealing element comprises: at least one tooth tip portion extending across at least a part of a substantially radially facing tip of at least one tooth of the stator; and at least one bridge section extending circumferentially across the radially oriented opening of the at least one slot and extending radially into the at least one slot; and
providing a supplementary sealing element forming a second layer extending around at least part of the circumference of the stator and co-operating with the sealing element to create at least one cavity between the bridge portion and the supplementary sealing element;
wherein the sealing element further comprises a filler material disposed within the at least one cavity formed by an inward extension of the bridge portion into the slot.
